(19) United States
(12) Patent Application Publication
(10) Pub. No.: US 2009/0096489 A1
(43) Pub. Date: Apr. 16, 2009

(54) HIGH VOLTAGE TOLERANT OVER-CURRENT DETECTOR

(75) Inventors: Wong Tak Ying, Singapore (SG); Rickey Setiawan, Singapore (SG)

Correspondence Address: BRAKE HUGHES BELLERMANN LLP;c/o CPA Global, P.O. Box 52050, Minneapolis, MN, 55402, US

(73) Assignee: BROADCOM CORPORATION, Irvine, CA (US)

(21) Appl. No.: 11/873,153

(22) Filed: Oct. 16, 2007

(51) Int. Cl. H02M 11/00

(52) U.S. Cl. 327/103

(57) ABSTRACT

A system comprising an over-current detector configured to receive a switching voltage signal and to produce a first and a second current signal; an current-to-voltage converter configured to convert the first and second current signals into a first and a second voltage signal; and a current mirror amplifier configured to utilize the first and second voltage signals to output an over-current condition signal when the switching signal has exceeded a threshold value.

### TECHNICAL FIELD

This description relates to switching regulators and more specifically to the detection of an over-current condition in the load current of the switching regulator or other device.

### BACKGROUND

A typical over-current detector may be used to monitor the load current of a device and determine if the load current is exceeding an allowed current level. An over-current detector is often used to prevent damage to a device and/or a fire resulting from the broken device. In some cases, too much current flow through a wire or other element, may generate too much heat and result in a fire.

The most well known over-current detection devices may be the fuse (or electrical fuse) and the circuit breaker. A fuse typically includes a metal wire that melts when too much current is applied to the device. The fuse may allow current flow below certain levels, but as the current exceeds a predetermined level, the wire melts, causing an open circuit in the device and stopping the current flow. Conversely a circuit breaker is typically an automated electrical switch. Unlike a fuse, which generally operates once and then must be replaced, a circuit breaker may be reset to resume normal operation. Like a fuse, the circuit breaker may allow normal operation below certain current levels, but once a threshold current level is achieved the circuit breaker may open a switch, causing an open circuit.

### SUMMARY

A system and/or method for detecting an over-current condition, substantially as shown in and/or described in connection with at least one of the figures, as set forth more completely in the claims.

### BRIEF DESCRIPTION OF THE DRAWINGS

FIG. 1 is a block diagram of an embodiment of a system for the detection of an over-current condition in accordance with the disclosed subject matter.

FIG. 2 is a schematic diagram of an embodiment of a circuit for the detection of an over-current condition in accordance with the disclosed subject matter.

FIG. 3 is a schematic diagram of an embodiment of a circuit for the detection of an over-current condition in accordance with the disclosed subject matter.

FIG. 4 is a schematic diagram of an embodiment of a circuit for the detection of an over-current condition in accordance with the disclosed subject matter.

FIG. 5 is a timing diagram of an embodiment of signals used in the detection of an over-current condition in accordance with the disclosed subject matter.

FIG. 6 is a timing diagram of an embodiment of signals used in the detection of an over-current condition in accordance with the disclosed subject matter.

FIG. 7 is a flowchart of an embodiment of a technique for the detection of an over-current condition in accordance with the disclosed subject matter.

### DETAILED DESCRIPTION

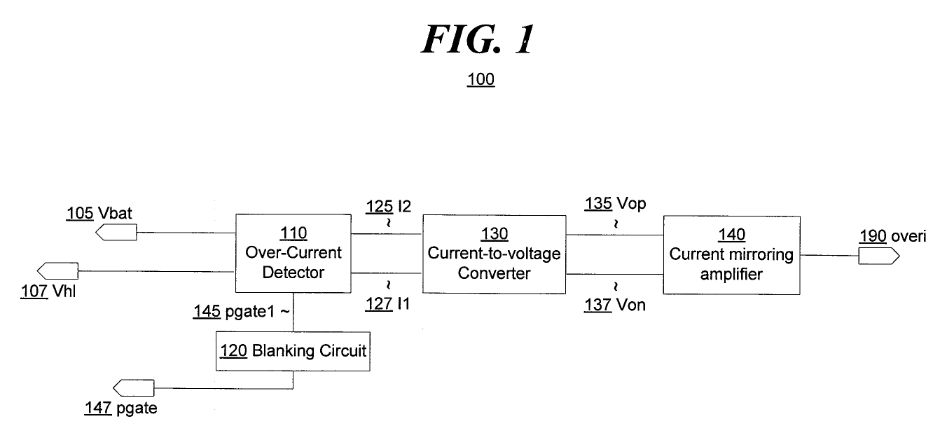

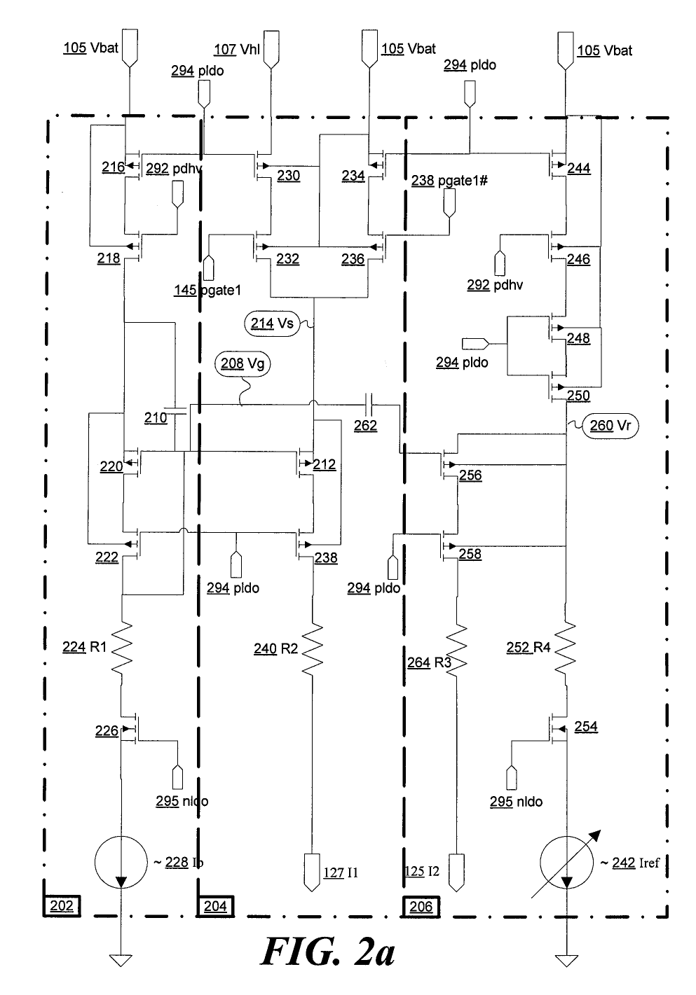

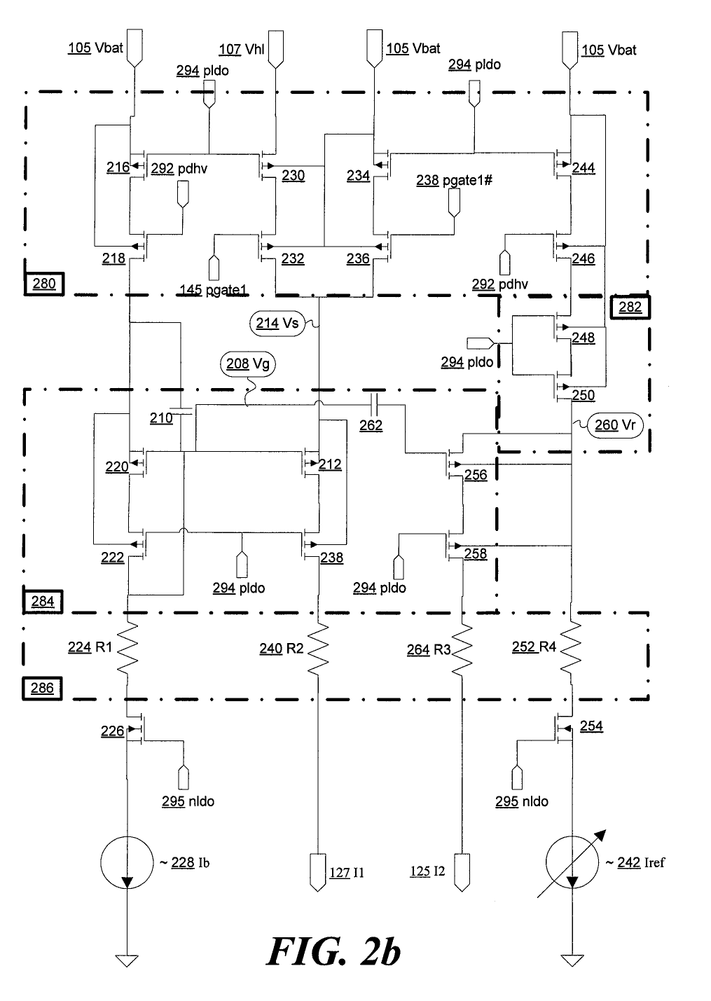

FIG. 1 is a block diagram of a system 100 for the detection of an over-current condition in accordance with the disclosed subject matter. In one embodiment, the system 100 may include an over-current detector 110, a blanking circuit 120, a current-to-voltage converter 130, and a current mirroring amplifier 140. In one embodiment, the system 100 may be used to detect when a measured current (not shown) exceeds a threshold current (also not shown). In one embodiment, an input signal 107 (Vh1) may be a voltage signal that is used to represent (or as a proxy for) the measured current. In one embodiment, the source voltage signal 105 (Vbat) may a voltage signal that is used to generate (or as a proxy for) for the threshold current. In another embodiment, the threshold current may be programmable or, alternatively, substantially predetermined. In one embodiment, illustrated in FIGS. 2a & 2b, the threshold current may be generated utilizing or essentially be a reference current. In one embodiment, the system 100 may output an over-current condition signal 190 which represents the state of the measured current.

In one embodiment, the system 100 may be used with a switching regulator (not shown). In one embodiment, the system 100 may monitor the load current of the switching regulator and assert an over-current condition signal when the load current is greater than a threshold current. In one embodiment, in which the switching regulator utilizes the source voltage signal 105 (Vbat), the load current of the switching regulator may be the current from the source voltage signal 105 (Vbat) to the load circuit. In this example embodiment, if an over-current condition is detected, steps may be taken to protect the switching regulator and any load device from the excess current. It is understood that this is merely one use and embodiment of the system 100, and other uses are expected and within the scope of the disclosed subject matter.

In one embodiment, the over-current detector 110 of system 100 may be configured to receive an input signal 107 (Vh1), and to produce a first current signal 127 (I1) and a second current signal 125 (I2). In one embodiment, the input signal 107 may be the switching voltage of a switching regulator, and may also be referred to as the switching voltage signal 107 (Vh1). In one embodiment, the input signal 107 may be the voltage applied to the load by the switching regulator. It is understood that, in one embodiment, while the input signal 107 may be measured in volts through the application of Ohm's Law (voltage is equivalent to current multiplied by resistance, V=IR) the input signal 107 may be representative of a load current. In one embodiment, this load current may be the current provided by the switching regulator to a load circuit.

In one embodiment, the over-current detector 110 may also receive a source voltage signal 105 (Vbat). In one illustrative embodiment, this source voltage signal 105 may be a battery voltage. However, it is understood that other forms of power supply and reference signals are within the scope of the disclosed subject matter. In one embodiment, the source voltage signal 105 may vary between a voltage of about 2.3V and about 5.5V, inclusive.

In one embodiment, the over-current detector 110 may also receive a control signal 145 (pgate1). This signal 145 may control when then the over-current detector 110 is turned “on” and attempting to detect an over-current condition.

In one embodiment, the control signal 145 (pgate1) may be generated by a blanking circuit 120 utilizing, at least in part, the raw control signal 147 (pgate). In one embodiment, the blanking circuit 120 may be configured to produce a control signal 145 (pgate1) that is conditioned to, at least in part, mask glitches and other unwanted characteristics in the input signal 107 (Vh1). In one embodiment, the input signal 107 may include switching noise or other transient characteristics on the rising and/or falling edge of the signal's transitions. In one embodiment, the blanking circuit 120 may be configured to delay the falling edge of the raw control signal 147 (pgate) sufficiently to reduce or completely mask the transient conditions expected to occur in the input signal 107. In one embodiment, this blanking may occur reactively, and the input signal 107 may be input into the blanking circuit 120. In another embodiment, an appropriate blanking duration to be used with the input signal 107 may be estimated during the design or manufacture of the circuit. It is understood that other blanking techniques may be employed and are within the scope of the disclosed subject matter.

In one embodiment, the over-current detector 110 may be configured to produce a first current signal 127 (I1) and a second current signal 125 (I2). In one embodiment, the system 100 may include a current-to-voltage converter 130 configured to convert the first and second current signals 125 and 127 into a first voltage signal 135 Vop and a second voltage signal 137 Von. In one embodiment, the current-to-voltage converter 130 may include a trans-impedance amplifier. In one embodiment, the trans-impedance amplifier may include an active current-to-voltage converter that may act as an amplifier with current input and voltage output. In one embodiment, the gain of this amplifier is represented by a resistance expressed in units of ohms. In one embodiment, the input of the current-to-voltage converter 130 may have a low impedance. In one embodiment, such an active current-to-voltage converter may be utilized in order to increase the responsiveness and reaction time of the system 100. In one embodiment, the response time of the system 100 may be measured as the time between the input representing an over-current condition and the detection thereof. It is understood that other conversion techniques may be used, including passive conversion, and are within the scope of the disclosed subject matter.

In one embodiment, the system 100 may include a current mirroring amplifier 140 configured to output an over-current condition signal 190 (overi) when the input signal 107 (Vh1) has exceeded a threshold value. In one embodiment, the current mirroring amplifier 140 may include an amplifier with a high-gain and wide bandwidth characteristics. It is also understood that other embodiments exist in which the system 100 does not utilizing a current mirroring amplifier but instead utilizes another amplifier configured to produce an over-current condition signal 190 by using the first voltage signal 135 Vop and a second voltage signal 137 Von.

FIGS. 2a and 2b are schematic diagrams of an embodiment of an over-current detector 110 for the detection of an over-current condition in accordance with the disclosed subject matter. FIG. 2a is a schematic diagram of the over-current detector 110 in which grouping boxes have been added to the schematic diagram to aid in the understanding of the embodiment of the disclosed subject matter. In one embodiment, the over-current detector 110 may include a first circuitry 202, a second circuitry 204, and a third circuitry 206.

In one embodiment, the first circuitry 202 may be configured to generate a biasing voltage 208 (informational bubble Vg). In one embodiment, the first circuitry 202 may pre-charge a capacitor 210 that provides, at least in part, the biasing voltage 208 (Vg). In one embodiment, the biasing voltage 208 may be pre-charged in order to reduce the noise coupling at the biasing voltage 208 (Vg) from the source voltage signal 105 (Vbat), specifically the gate of transistor 212. If the gate of transistor 212 is properly biased before the over-current detector is turned on, and therefore the selected voltage 214 (informational bubble Vs) is applied to the source of transistor 212, the transistor 212 may not experience a high gate-source voltage and therefore may not reach its breakdown voltage. In this context, the breakdown voltage may be considered to be a parameter of a solid state device that defines the largest reverse voltage potential that can be applied without causing an exponential increase in the current in the device. In one embodiment, the transistor 212, and in some embodiments all transistors illustrated in FIGS. 2a and 2B, may withstand or have a breakdown voltage of about 2.75V and not more than about 4.1V for voltage spikes.

In one embodiment, the first circuitry 202 may include the input of a source voltage signal Vbat 105 (shown multiple times). In one embodiment, the source voltage may be a battery voltage. However, it is understood that while the term battery voltage is commonly used in the art that other forms of power supply, both to the device and its individual circuits, may be utilized and are within the scope of the disclosed subject matter. In one embodiment, this source voltage signal 105 may include a voltage of substantially 5.5V, although it is understood that fluctuation is within the scope of even this specific embodiment of the disclosed subject matter. In one embodiment, the first circuitry 202 may also include the input of a power-down high-voltage signal pdhv 292 (shown multiple times) and the input of a low-voltage dropout signal pldo 294 (shown multiple times). In one embodiment, the power-down high-voltage signal pdhv 292 and the input of a low-voltage dropout signal pldo 294 may be considered substantially constant direct-current (DC) voltages.

In one embodiment, the source voltage signal 105 may pass through two cascaded transistors 216 and 218. In one embodiment, these transistors may be configured to provide high-voltage protection to the other transistors of the first circuitry 202. The cascading nature of the configuration may allow the source voltage signal 105 to experience two threshold voltage (Vth) drops before reaching the output (the drain of transistor 218), and therefore reducing the voltage seen by the other transistors of the first circuitry 202. In one embodiment, the cascading nature of the configuration may ensure that the gate-source voltage (Vgs) and gate-to-drain voltage (Vgd) of the transistors are less than the transistor's gate oxide breakdown voltage.

In one embodiment, the source of transistor 216 may be coupled with the source voltage signal 105. The gate of transistor 216 may be coupled with the low-voltage dropout signal 294 (pldo). The drain of transistor 216 may be coupled with the source of transistor 218. The gate of transistor 218 may be coupled with the power-down high-voltage signal 292 (pdhv). The body or substrate of the transistors 216 and 218 may be coupled with the source voltage signal 105 (Vbat). In one embodiment, the transistors 216 and 218, and in various embodiments other transistors of the over-current detector 110, may be a positive channel metal-oxide semiconductor (PMOS) transistor manufactured by a conventional complementary metal-oxide semiconductor (CMOS) process. In one embodiment, the transistors may be manufactured using a 65 nm process. Such a process may result in a transistor that may withstand or have a breakdown voltage of about 2.75V and not more than about 4.1V for voltage spikes. However, it is understood that this is merely one illustrative embodiment and other embodiments are within the scope of the disclosed subject matter. In one embodiment, the transistors may be PMOS transistors, although negative channel metal-oxide semiconductor (NMOS) transistors are within the scope of the disclosed subject matter. Furthermore, it is also understood that while only two transistors are illustrated in the embodiment shown in FIGS. 2a and 2b other transistor configurations and pluralities are within the scope of the claimed disclosed subject matter and may, in one embodiment, include Laterally Diffused MOS (LDMOS) transistors.

In one embodiment, the first circuitry 202 may also include biasing transistor 220 and High-voltage (HV) protection transistor 222. In one embodiment, these transistors may be configured to generate the biasing voltage 208 (Vg). In one embodiment, the capacitor 210 may be connected across the source and gate of transistor 220. In one embodiment, the capacitor 210 may be useful for reducing any transient spikes across the gate and source of the transistor 220. In one embodiment, the capacitor may allow for a substantially constant gate voltage at the gate of transistor 220, and therefore a constant biasing voltage 208 (Vg). In one embodiment, the source of transistor 220 may be coupled with capacitor 210 and the drain of transistor 218. Likewise, the body of transistors 220 and 222 may be coupled with the drain of transistor 218. The drain of transistor 220 may be coupled with the source of transistor 222. The gate of transistor 222 may be coupled with the low-voltage dropout signal 294 (pldo). As demonstrated, in this embodiment, the transistor 220 may be diode-connected in order to prevent the breakdown of the transistors 220, 212, and 256 in a condition where an over-voltage or abnormally high voltage condition exists.

In one embodiment, the first circuitry 202 may include a resistor 224 (R1) configured to, at least in part, reduce leakage current when the circuit is in a low-power mode (e.g., a power down mode), and to, at least in part, attempt to prevent the high voltage breakdown of the transistors of the first circuitry 202. In one embodiment, the resistor 224 may also be configured to prevent the high voltage breakdown of the transistors of the over-current detector 110.

In one embodiment, the first circuitry 202 may include a transistor 226 configured to prevent a current source 228 (Ib) from experiencing breakdown or damage from the high voltage experienced by the over-current detector 110 during operation. Once again, in one embodiment, the over-current detector 110 may be comprised of solid state devices with a breakdown voltage below that of the source voltage 105 (Vbat), and therefore unless properly configured the solid-state devices may be damaged. In one embodiment, the current source 228 (Ib) may provide a direct current source. In one embodiment, the current source 228 may not be part of, or included within, the over-current detector 110. In one embodiment, the transistor 226 may be an NMOS transistor. In one embodiment, the drain of the transistor 226 may be coupled with the resister 224. The source and body of the transistor may be coupled with the current source 228. The gate may be coupled with an NMOS version of the low-voltage dropout signal 295 (nldo, and shown multiple times).

In one embodiment, the second circuitry 204 may be configured to generate a first current 127 signal (I1) based upon a selection of either a source voltage signal 105 (Vbat) or a switching voltage signal 107 (Vh1). In one embodiment, the second circuitry 204 may select the source voltage signal 105 when the over-current detector is turned “off” or reset. In one embodiment, the second circuitry 204 may select the switching voltage signal 107 (Vh1) when the over-current detector is turned “on” or active. In one embodiment, the selected voltage 214 (informational bubble Vs) may be converted into a first current signal 127 (I1).

In one embodiment, the second circuitry 204 may include high-voltage (HV) power-down switching transistors 230, 232, 234, and 236. In one embodiment, these transistors may be configured in a cascading fashion. The cascading nature of the configuration may allow the source voltage signal 105 or the switching voltage 107, respectively, to experience two threshold voltage (Vth) drops before reaching the output (the drains of transistors 232 and 236), and therefore reduce the voltage seen by the other transistors of the second circuitry 204. In one embodiment, the cascading nature of the configuration may ensure that the gate-source voltage (Vgs) and gate-to-drain voltage (Vgd) of the transistors are less than the transistor's gate oxide breakdown voltage. It is also understood that while only two transistors are illustrated in the embodiment shown in FIGS. 2a and 2b other transistor configurations and pluralities are within the scope of the claimed disclosed subject matter and may, in one embodiment, include Laterally Diffused MOS (LDMOS) transistors.

In one embodiment of the second circuitry 204, the source of transistor 230 may be coupled with the switching voltage signal 107 (Vh1). The gate of transistor 230 may be coupled with the low-voltage dropout signal 294 (pldo). The drain of transistor 230 may be coupled with the source of transistor 232. The drain of the transistor 232 may be configured to provide, at least in part, selected voltage 214 (informational bubble Vs). The gate of the transistor 232 may be coupled with the control signal 145 (pgate1). In one embodiment, the control signal 145 (pgate1) may be pre-processed in order to reduce any glitches or electrical transients experienced by the system 100 of FIG. 1, and any of its elements.

Likewise, in one embodiment of the second circuitry 204, the source of transistor 234 may be coupled with the source voltage signal 107 (Vbat). The gate of transistor 234 may be coupled with the low-voltage dropout signal 294 (pldo). The drain of transistor 234 may be coupled with the source of transistor 236. The drain of the transistor 236 may be configured to provide, at least in part, selected voltage 214 (Vs). The gate of the transistor 236 may be coupled with the inverse control signal 238 (pgate1#). In one embodiment, the inverse control signal 238 may be the compliment or opposite of control signal 145 (pgate1). In one example, when pgate1 145 is “high”, pgate1# 238 is “low” and vice versa. In one embodiment, the inverse control signal 238 may be produced utilizing an inverter. In another embodiment, the inverse control signal 238 (pgate1#) may be delayed or altered such that no overlap exists between it and the control signal 145 (pgate1). In one embodiment, the body or substrate of the transistors 230, 232, 234, and 236 may be coupled with the source voltage signal 105 (Vbat).

In one embodiment, the control signal 145 (pgate1) may turn “on” the transistor 232 when the over-current detector 110 is active or “on”. This may allow, in one embodiment, the selected voltage 214 (Vs) to become substantially equivalent to the switching voltage 107 (Vh1). Although it is understood that gate resistance and threshold voltage drops may occur in some embodiments. Likewise, when the control signal 145 (pgate1) is “on”, the inverse control signal 238 (pgate1#) is “off” and therefore the transistor prevents, in one embodiment, the source voltage 105 (Vbat) from being communicated to the selected voltage (214). Conversely, in one embodiment, when the inverse control signal (pgate1#) is “on” the control signal 145 (pgate1), and therefore the over-current detector 110, is “off” and the selected voltage 214 (Vs) may become substantially equivalent to the source voltage 105 (Vbat). In one embodiment, the control signal 145 (pgate 1) may be thought of as a selector that selects between the source voltage signal 105 (Vbat) and the switching voltage signal 107 (Vh1).

In one embodiment, the second circuitry 204 may include a high-voltage (HV) voltage-to-current converter, shown in this embodiment as transistor 212 and HV protection transistor 238. In one embodiment, these transistors may be configured to convert, the least in part, the selected voltage 214 (Vs) into a first current 127 (I1). In one embodiment, the source of transistor 212 may be coupled with the drain of transistors 232 and 236, which produce the selected voltage 214 (Vs). Likewise, the body of transistors 212 and 238 may be coupled with the drain of transistors 232 and 236. The gate of transistor 212 may be coupled with the biasing voltage 208 (Vg). As described above, the gate of transistor 212 may be pre-charged or biased in order to reduce the coupling noise at biasing voltage 208 (Vg) from the source voltage signal 105 (Vbat). The drain of transistor 212 may be coupled with the source of transistor 238. The gate of transistor 238 may be coupled with the low-voltage dropout signal 294 (pldo). As demonstrated, in this embodiment, the transistors 212 & 238 may be configured to protect themselves or ameliorate a condition where an over-voltage or abnormally high voltage condition exists.

In one embodiment, the second circuitry 204 may include a resistor 240 (R2) configured to, at least in part, reduce leakage current when the circuit is in a low-power mode (e.g., a power down mode), and to, at least in part, attempt to prevent the high voltage breakdown of the transistors of the second circuitry 204. In one embodiment, the resistor 240 may also be configured to prevent the high voltage breakdown of the transistors of the over-current detector 110. In one embodiment, the resistor 240 may be coupled between the drain of transistor 238 and the output of the first current signal 127 (I1).

In one embodiment, the over-current detector 110 may include third circuitry 206 configured to generate a second current signal 125 (I2) based upon a reference voltage. In one embodiment, the reference voltage may be derived, at least in part, from a reference current 242 (Iref). In one embodiment, this reference current 242 (Iref) may be substantially programmable.

In one embodiment, the third circuitry 206 may include high-voltage (HV) power-down switching transistors 244 and 246. In one embodiment, these transistors may be configured in a cascading fashion. The cascading nature of the configuration may allow the source voltage signal 105 to experience two threshold voltage (Vth) drops before reaching the output (the drain of transistor 246), and therefore reducing the voltage seen by the other transistors of the third circuitry 206. In one embodiment, the cascading nature of the configuration may ensure that the gate-source voltage (Vgs) and gate-to-drain voltage (Vgd) of the transistors are less than the transistor's gate oxide breakdown voltage.

In one embodiment, the source of transistor 244 may be coupled with the source voltage signal 105. The gate of transistor 244 may be coupled with the low-voltage dropout signal 294 (pldo). The drain of transistor 244 may be coupled with the source of transistor 246. The gate of transistor 246 may be coupled with the power-down high-voltage signal 292 (pdhv). The body or substrate of the transistors 244 and 246 may be coupled with the source voltage signal 105 (Vbat). It is also understood that while only two transistors are illustrated in the embodiment shown in FIG. 2 other transistor configurations and pluralities are within the scope of the claimed disclosed subject matter and may, in one embodiment, include Laterally Diffused MOS (LDMOS) transistors.

In one embodiment, the third circuitry 206 may include a programmable voltage reference generator configured to generate a reference voltage 260 (informational bubble Vr). In one embodiment, the programmable voltage reference generator may include transistors 248 and 250 and reference current 242 (Iref). In one embodiment, the source of transistor 248 may be coupled with the drain of transistor 246. The drain of transistor 248 may be coupled with the source of transistor 250. The voltage at the drain of transistor 250 may be considered the reference voltage 260 (Vr). Both the gates of transistors 248 and 250 may be coupled with the low-voltage dropout signal 294 (pldo). Both of the bodies or substrates of transistors may be coupled with the source voltage signal 105 (Vbat).

In one embodiment the switching regulator may include a set of cascading transistors used, in part, for HV breakdown protection. In such an embodiment, the characteristics of the transistors comprising the programmable voltage reference generator (e.g., transistors 248 and 250) may be matched with the cascading transistors of the switching regulator. In another embodiment, if the switching regulator does not include a cascaded HV breakdown protection transistors, some or all of the transistors comprising the programmable voltage reference generator may be removed, while, in various embodiments, the remaining transistors may be matched with their counterpart sin the switching regulator. In one specific non-limiting embodiment, transistor 250 may be remove while the characteristics of transistor 248 are matched with a comparable transistor in the switching regulator.

In one embodiment, the transistors 248 and 250 may convert the current provided by reference current 242 (Iref) into a voltage via the transistors' channel resistance. In one embodiment, the reference current 242 (Iref) may be much greater than the current provided by the current source 228 (Ib). In this embodiment, the voltage drop caused by transistors 248 and 250 may be considered to simply be the resistance of the transistors multiplied by the reference current. In one embodiment programmability may be provided by providing a programmable current source to provide the reference current 242 (Iref). In one embodiment, the programmability may be a result of the resistance of the transistors 248 and 250.

Furthermore, it is also understood that while only two transistors are illustrated in the embodiment shown in FIG. 2 (transistors 248 and 250) other transistor configurations and pluralities are within the scope of the claimed disclosed subject matter and may, in one embodiment, include Laterally Diffused MOS (LDMOS) transistors. In some embodiments, the programmability of the voltage may result from the dynamic configuration or switching of the transistors. In one embodiment, the process-voltage-temperature (PVT) characteristics of the transistors 248 and 250 may vary as a result of manufacturing. Therefore, as this may change the resistance of the transistors, care may be taken, in some embodiments, to match the PVT characteristics of the transistors with other components of the device and possibly the switching regulator.

In one embodiment, the third circuitry 206 may include a resistor 252 (R4) configured to, at least in part, reduce leakage current when the circuit is in a low-power mode (e.g., a power down mode), and to, at least in part, prevent the high voltage breakdown of the transistors of the third circuitry 206. In one embodiment, the resistor 252 may also be configured to prevent the high voltage breakdown of the transistors of the over-current detector 110.

In one embodiment, the third circuitry 206 may include a transistor 254 configured to prevent a reference current source 242 (Iref) from experiencing breakdown or damage from the high voltage experienced by the over-current detector 110 during operation. Once again, in one embodiment, the over-current detector 110 may include solid state devices having a breakdown voltage below that of the source voltage 105 (Vbat), and therefore, unless properly configured, the solid-state devices may be damaged. In one embodiment, the reference current source 242 (Iref) may provide a direct current source. In one embodiment, the reference current source 242 (Iref) may be not be part of, or included as part of the over-current detector 110. Alternatively in another embodiment, the reference current source 242 (Iref) may be a separate component from the over-current detector 110. In one embodiment, the transistor 254 may be an NMOS transistor. In one embodiment, the drain of the transistor 254 may be coupled with the resister 252. The source and body of the transistor may be coupled with the current source 242. The gate may be coupled with an NMOS version of the low-voltage dropout signal 295 (nldo, and shown multiple times).

In one embodiment, the third circuitry 206 may include a high-voltage (HV) voltage-to-current converter, shown in this embodiment as transistor 256 and HV protection transistor 258. In one embodiment, these transistors may be configured to convert, the least in part, the reference voltage 260 (Vr) into a second current 125 (I2). In one embodiment, the source of transistor 256 may be coupled with the drain of transistor 250, which produces the reference voltage 260 (Vr). Likewise, the body of transistors 256 and 258 may be coupled with the drain of transistor 250. The gate of transistor 256 may be coupled, in one embodiment, with the biasing voltage 208 (Vg) via capacitor 262. In such an embodiment, transistor 256 may be considered to be electrically coupled or connected with the output of the first circuitry 202, even though capacitor 262 physically separates the two components. In one embodiment, the capacitor 262 may be configured to reduce, at least in part, any unwanted voltage transients or glitches in the biasing voltage 208 (Vg). In one embodiment, such voltage transients may occur when the over-current detector 110 is switched “on” and “off”. As described above, the gate of transistor 256 may be pre-charged or biased in order to reduce the noise coupling at the biasing voltage 208 (Vg) from the source voltage signal 105 (Vbat). The drain of transistor 256 may be coupled with the source of transistor 258. The gate of transistor 258 may be coupled with the low-voltage dropout signal 294 (pldo). As demonstrated, in this embodiment, the transistor 256 & HV transistor 258 may be configured to protect themselves or ameliorate a condition where an over-voltage or abnormally high voltage condition exists.

In one embodiment, the third circuitry 206 may include a resistor 264 (R3) configured to, at least in part, reduce leakage current when the circuit is in a low-power mode (e.g., a power down mode), and to, at least in part, prevent the high voltage breakdown of the transistors of the third circuitry 206. In one embodiment, the resistor 264 may also be configured to prevent the high voltage breakdown of the transistors of the over-current detector 110. In one embodiment, the resistor 240 may be coupled between the drain of transistor 258 and the output of the first current signal 125 (I2).

FIGS. 2a and 2b are schematic diagrams of an embodiment of an over-current detector 110 for the detection of an over-current condition in accordance with the disclosed subject matter. FIG. 2b is a schematic diagram of the over-current detector 110 in which grouping boxes have been added to the schematic diagram to aid in the understanding of the embodiment of the disclosed subject matter. In one embodiment, the over-current detector 110 may include a blanking circuit 120, a group of high-voltage (HV) power-down switches 280, a programmable voltage reference generator 282, a group of high-voltage (HV) voltage-to-current converters 284, and a group of leakage reduction resistors 286.

In one embodiment, the group of high-voltage (HV) power-down switches 280 may be configured to reduce, at least in part, the voltage differential (e.g., the gate-source voltage (Vgs) and gate-to-drain voltage (Vgd)) experienced by the group of high-voltage voltage-to-current converters 284 and wherein at least a portion of the HV power-down switches 280 is controlled by the control signal 145 (pgate1). In one embodiment, the group of high-voltage (HV) power-down switches 280 may include transistors 216, 218, 230, 232, 234, 236, 244, and 246, which may perform this voltage reduction as described above. In one embodiment, these eight transistors may be thought of as four sets of two cascaded transistors, grouped as transistors 216 and 218, 230 and 232, 234 and 236, and 244 and 246. Although, it is understood this is merely one illustrative embodiment, and other sets and configurations of transistors or other elements are within the scope of the disclosed subject matter.

In one embodiment, the portion of the HV power-down switches may include transistors 232 and 236 that may be controlled by a control signal 145 (pgate1) to select between the switching voltage signal 107 (Vh1) and a source voltage signal 105 (Vbat). In one embodiment, when the over-current detector 110 is “on”, the control signal 145 (pgate1) may select the switching voltage signal 107 (Vh1) and, when the over-current detector is “off” select the source voltage signal 105 (Vbat). In one embodiment, the control signal 145 (pgate 1) may be though of as controlling the entire two transistors sets, transistors 230 and 232, and 234 and 236.

In one embodiment, the programmable voltage reference generator 282 may be configured to generate a reference voltage 260 (Vr). In one embodiment, the programmable voltage reference generator 282 may include transistors 248 and 250, which may perform this generation as described above. In another embodiment, the programmable voltage reference generator 282 may also include the programmable reference current source 242 (Iref), which may perform this generation as described above.

In one embodiment, the group of high-voltage (HV) voltage-to-current converters 284 may be configured to receive the output of the HV power-down switches 280 and the programmable voltage reference generator and produce a first current signal 127 (I1) and a second current signal 125 (I2). In one embodiment, the group of high-voltage (HV) voltage-to-current converters 284 may include transistors 220, 222, 212, 238, 256 and 258, which may perform this conversion as described above.

In one embodiment, the group of high-voltage (HV) voltage-to-current converters 284 may include a gate bias voltage generator configured to generate a biasing voltage 208 (Vg) in order to prevent the high voltage breakdown of at least a portion of the group of high-voltage (HV) voltage-to-current converters 284. In one embodiment, the gate bias voltage generator may include transistors 220 and 222 and capacitor 210, which may perform this conversion as described above.

In one embodiment, the group of leakage reduction resistors 286 may be configured to reduce the leakage current of the over-current detector 110 when the detector is in a low power or power-down mode. In one embodiment, the group of leakage reduction resistors 286 may include resistors 224, 240, 254, and 264, which may perform this conversion as described above.

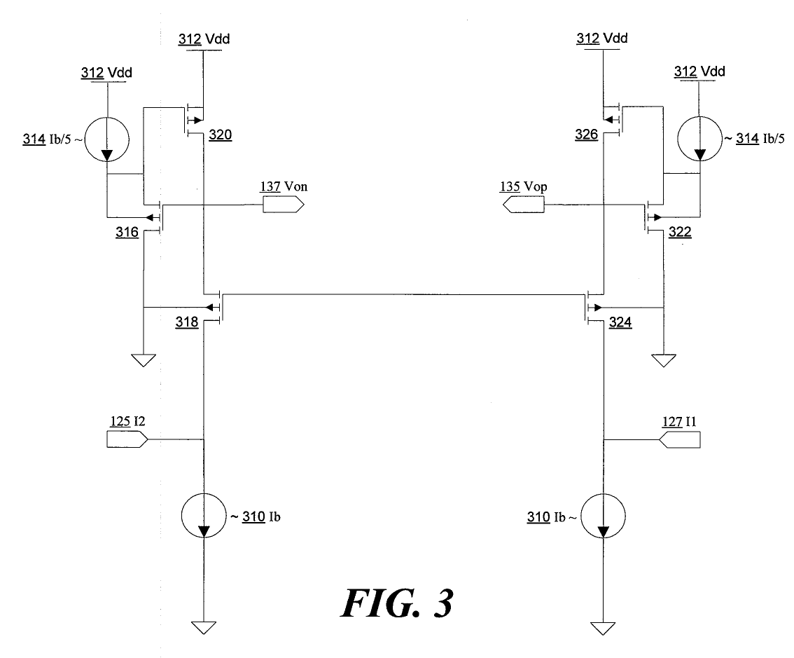

FIG. 3 is a schematic diagram of an embodiment of a current-to-voltage converter 130 for the detection of an over-current condition in accordance with the disclosed subject matter. In one embodiment, the current-to-voltage converter 130 configured to convert the first and second current signals 125 (I2) and 127 (I1) into a first voltage signal 135 Vop and a second voltage signal 137 Von. In one embodiment, the current-to-voltage converter 130 may include a trans-impedance amplifier, as illustrated by FIG. 3.

In one embodiment, the current-to-voltage converter 130 may include an active inductive load. In one embodiment, the active inductive load may provide a low gain and a high bandwidth response for the current-to-voltage converter 130. In one embodiment, this active load may include a trans-impedance amplifier (TIA). In one embodiment, the active inductive load may include two circuitries or legs. The first leg may include, in one embodiment, transistors 322, 324 and 326, and may receive the first current signal 127 (I1) as an input and generate the first voltage signal 135 (Vop) as an output. The second leg may include, in one embodiment, transistors 316, 318 and 320, and may receive the second current signal 125 (I2) as an input and generate the second voltage signal 137 (Von) as an output.

In one embodiment, the first circuitry or leg of the current-to-voltage converter 130 may include a current source 314 that produces a current that is about one fifth of the current produced by the current source 310 (Ib). A modified source voltage 312 (Vdd) may be applied to the current source. In one embodiment, the modified source voltage 312 (Vdd) may be derived from the source voltage 105 (Vbat) and, in one specific embodiment, have a voltage range of substantially 2.5V.

In one embodiment, the first circuitry or leg of the current-to-voltage converter 130 may include a transistor 326 whose source and body are coupled with the modified source voltage 213 (Vdd). The gate of transistor 326 may be coupled with the source and body of a transistor 322 and the current source 314 (Ib/5). In various embodiments, the current source 314 may utilize other values, such as, for example, Ib or Ib/2. It is understood that the embodiment illustrated, where current source 314 is Ib/5 is merely one example embodiment, and that the disclosed subject matter is not so limited. The gate of transistor 322 may be coupled with the drain of transistor 326 and the source of transistor 324. The drain of transistor 322 and the body of transistor 324 may be coupled with a ground. The drain of transistor 324 may be coupled with the current source 310 (Ib).

In one embodiment, the first current signal 127 (I1) may be coupled with the current-to-voltage converter 130 at the drain of transistor 324. Because the current Ib remains substantially constant, as the first current signal 127 (I1) varies the current through transistor 324 may adjust to compensate. The resistance of the active inductive load combined with the current flow though the transistor 324 may create a voltage drop across the transistors. In one embodiment, the source of transistor 324 may be the output first voltage signal 137 (Von).

In one embodiment, the second circuitry or leg of the current-to-voltage converter 130 may include structures mirroring or analogous to the structures of the first leg. In one embodiment, transistor 320 may be analogous to transistor 326. Transistor 316 may be analogous to transistor 322. Transistor 318 may be analogous to transistor 324. In one embodiment, the second circuitry or leg of current-to-voltage converter 130 may receive the second current signal 125 (I2) as an input and produce the second voltage signal 137 (Von) as an output.

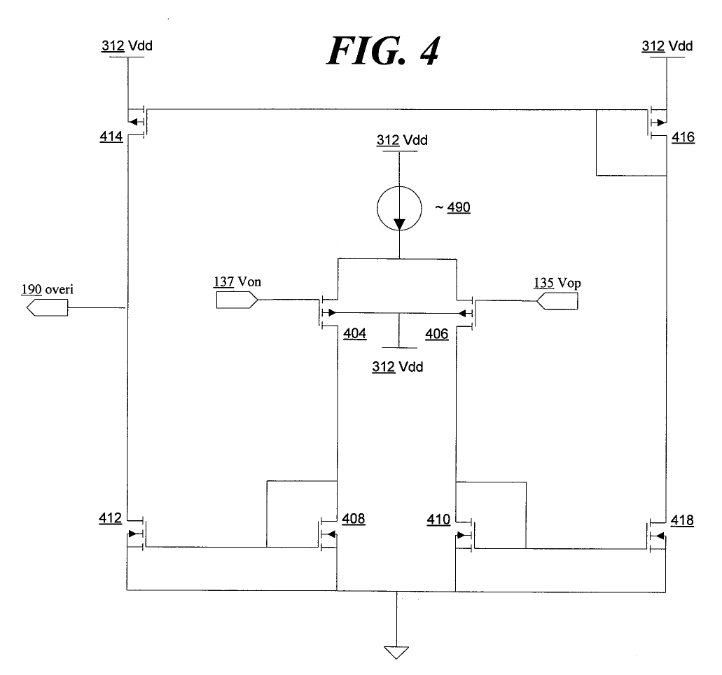

FIG. 4 is a schematic diagram of an embodiment of a current mirroring amplifier 140 for the detection of an over-current condition in accordance with the disclosed subject matter. In one embodiment, the current mirroring amplifier 140 may be configured to output an over-current condition signal 190 (overi) when the input (or switching) signal 107 (Vh1) has exceeded a threshold value. In one embodiment, the current mirroring amplifier 140 may include an amplifier with a high-gain and wide bandwidth characteristics. It is also understood that other embodiments, exist in which the system 100 does not utilizing a current mirroring amplifier but instead another amplifier configured to produce an over-current condition signal 190 by utilizing the first voltage signal 135 Vop and a second voltage signal 137 Von.

In one embodiment, the current mirror amplifier 140 may include two substantially identical circuitries or sides. In one embodiment, one circuitry or side may include a transistor 404. The source of transistor 404 may be coupled with a current source 490. The body of transistor 404 may be coupled with the modified source voltage 312 (Vdd). The drain of transistor 404 may be coupled with the gate and drain transistor 408. The gate of the transistor 404 may be coupled with the second voltage signal 137 (Von). In one embodiment, the body and source of transistors 408 and 412 may coupled with a ground. The gate of transistor 412 may be coupled with the gate of transistor 408 and the drain of transistor 404. The drain of transistor 412 may be the output port for the over-current condition signal 190 (overi). The drain of transistor 414 may be coupled to the drain of transistor 412. The gate of transistor 414 may be coupled to the gate of transistor 416. The body and source of transistor 414 may be coupled with the modified source voltage 312 (Vdd).

In one embodiment, the other circuitry or side of current mirror amplifier 140 may be analogous or a mirror image of the first circuitry or side. In one embodiment, transistor 404 may be analogous to transistor 406. Transistor 408 may be analogous to transistor 410. Transistor 412 may be analogous to transistor 418. Transistor 414 may be analogous to transistor 416. The second voltage signal 137 (Von) may be analogous with the first voltage signal 135 (Vop).

In one embodiment, the current mirror amplifier 140 may be a circuit designed to copy a current through one active device by controlling the current in another active device of a circuit, keeping the output current constant regardless of loading. The current being copied may be, in one embodiment, a varying signal current. In one embodiment, the over-current detection signal 190 (overi) may be a voltage that varies as the current mirror copies the current resultant due, at least in part, to the first voltage signal 135 (Vop).

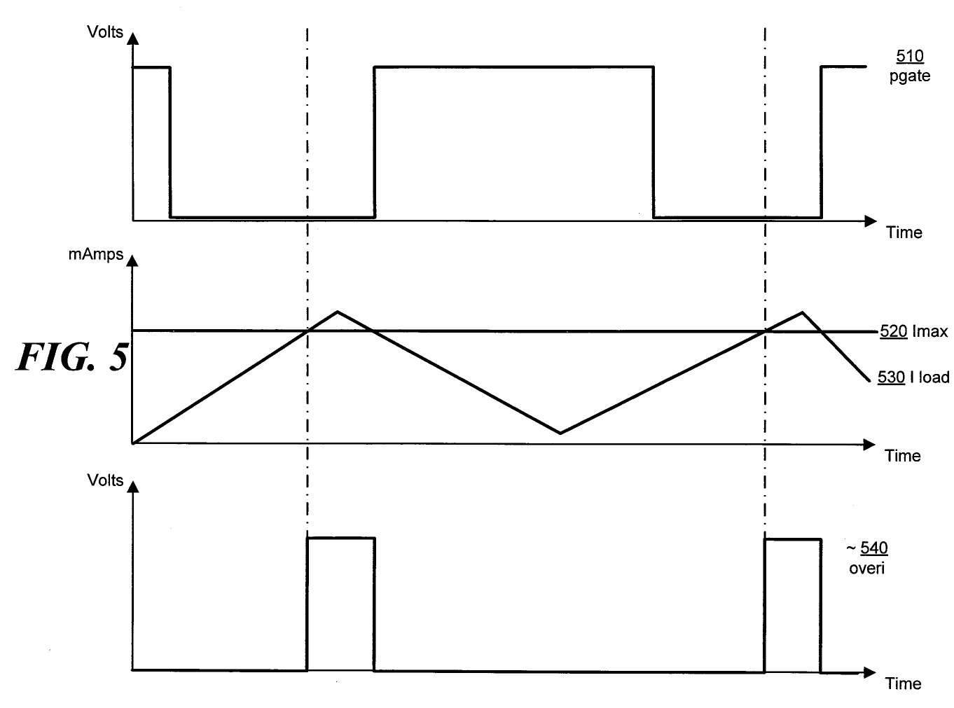

FIG. 5 is a timing diagram of an embodiment of signals used in the detection of an over-current condition in accordance with the disclosed subject matter. In one embodiment the raw control signal 510 (pgate) is shown transitioning between an “on” (or “low”) state and an “off” (or “high”) state. It is understood that various forms of the control may be used and the disclosed subject matter is not limited to this one illustrative example. Also shown is, one embodiment, of the threshold current 520 (Imax). As described above in reference with FIGS. 2a and 2b, the threshold current 520 (Imax) may be programmable. In one embodiment, the threshold current 520 (Imax) may be set utilizing a reference current. The load current 530 (Iload), in one embodiment, is shown. It is understood that many load currents may exist and that this is merely one illustrative embodiment. As described above in reference to FIGS. 1 and 2, the load current 530 (Iload) may be inferred, in some embodiments, utilizing the switching voltage 107 (Vh1). The over-current condition signal 190 (overi) illustrates that, in one embodiment, when the load current 530 exceeds the threshold current 520 and the control signal 510 indicates that the over-current detector is active (or “on”), that an over-current condition may be indicated.

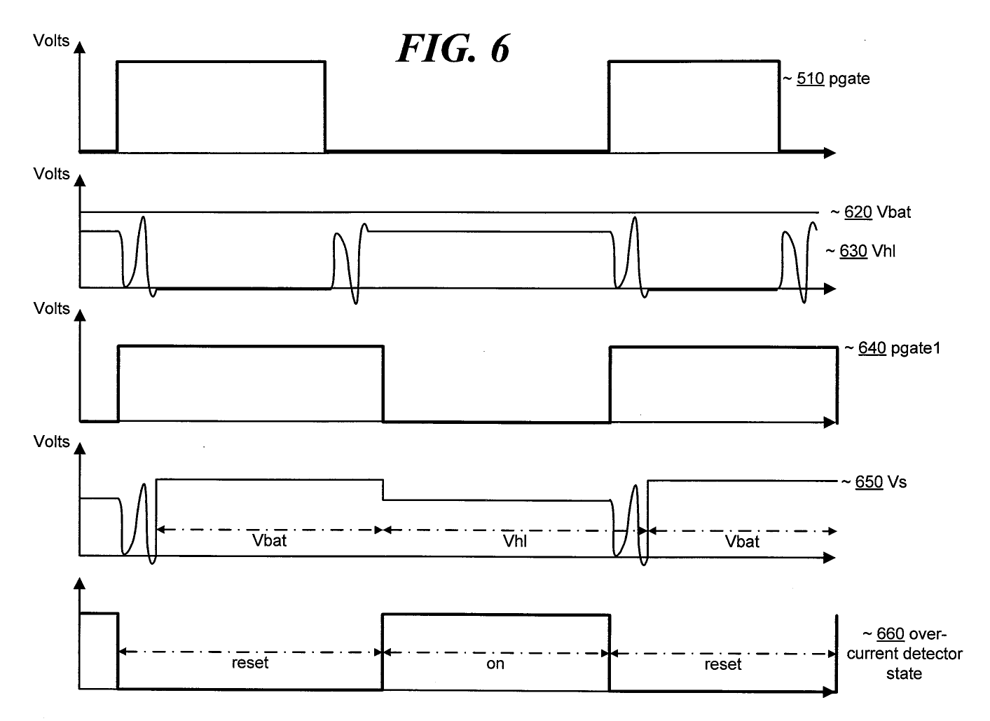

FIG. 6 is a timing diagram of an embodiment of signals used in the detection of an over-current condition in accordance with the disclosed subject matter. As described in reference to FIG. 5, the raw control signal 510 (pgate) is shown in one embodiment. The source voltage signal 620 (Vbat) illustrates that, in one embodiment, the source voltage signal 620 may be a substantially constant direct current (DC) voltage. The switching voltage signal 630 (Vh1) illustrates that, in one embodiment, the switching voltage signal may substantially alternate or switch between two levels. The switching voltage signal 630 also illustrates that, in one embodiment, voltage ringing or other electrical transients may accompany the transition from one level to the other. In one embodiment, the switching voltage signal 630 may remain substantially below the source voltage signal 620. Although, it is understood that other embodiments are within the scope of the disclosed subject matter and that, in some embodiments, electrical transients may temporarily bring the switching voltage signal 630 above the level of the source voltage signal 620.

The control signal 640 (pgate1) illustrates that in one embodiment, the raw control signal 510 (pgate) may be conditioned or blanked in order to mask expected electrical transients in the switching voltage signal 630 (Vh1). In the illustrated embodiment, the falling edge of the raw control signal 510 (pgate) is extended past the expected electrical transients of the switching voltage signal 630 (Vh1). In this illustrative embodiment, the rising edge of the raw control signal 510 (pgate) already overlapped and masks the rising edge electrical transients of the switching voltage signal 630 (Vh1).

The selected voltage 650 (Vs) illustrates that, in one embodiment, the control signal 640 (pgate1) may determine whether the source voltage signal 620 (Vbat) or the switching voltage signal 630 (Vh1) is selected. In one embodiment, the over-current detector 110 described above may make this selection. The over-current detector state 660 illustrates that, in one embodiment, the state of the over-current detector 110 may be determined by the control signal 640 (pgate1).

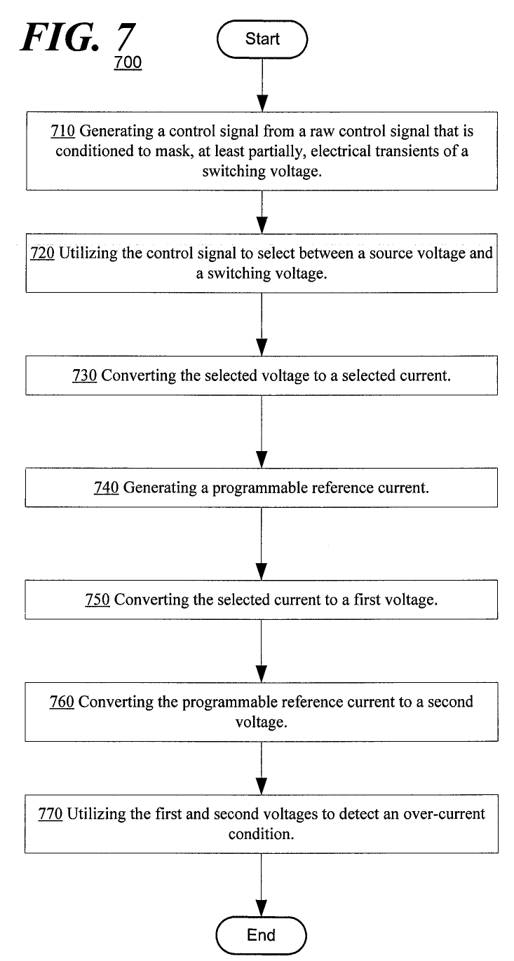

FIG. 7 is a flowchart of an embodiment of a technique for the detection of an over-current condition in accordance with the disclosed subject matter. Block 710 illustrates that, in one embodiment, a control signal may be generated from a raw control signal that is conditioned to mask, at least partially, electrical transients of a switching voltage signal. In one embodiment, the blanking generator 120 of FIG. 1 may perform the control signal generation as described above.

Block 720 illustrates that, in one embodiment, the control signal may be utilized to select either a source voltage or a switching voltage. In one embodiment, portions of the over-current detector 110 of FIG. 1 may perform this selection as described above. Specifically, in one illustrative embodiment, transistors 230, 232, 234 and 236 may perform this selection, as described above.

Block 730 illustrates that, in one embodiment, the selected voltage may be converted into a selected or first current. In one embodiment, portions of the over-current detector 110 of FIG. 1 may perform this selection as described above. Specifically, in one illustrative embodiment, transistors 212 and 238 may perform this conversion, as described above. In one embodiment, the selected current may be the first current signal 127 (I1), described above.

Block 740 illustrates that, in one embodiment, programmable reference current may be generated. In one embodiment, portions of the over-current detector 110 of FIG. 1 may perform this generation as described above. Specifically, in one illustrative embodiment, the third circuitry 206 of the over-current detector 110 may perform this generation, as described above. In one embodiment, the programmable reference current may be the second current signal 125 (I2), described above.

Block 750 illustrates that, in one embodiment, the selected current may be converted into a first voltage. In one embodiment, portions of the current-to-voltage converter 130 of FIG. 1 may perform this conversion as described above. Specifically, in one illustrative embodiment, the transistors 322, 324 and 326 may perform this conversion, as described above. In one embodiment, the first voltage may be the first voltage signal 135 (Vop), described above.

Block 760 illustrates that, in one embodiment, the programmable reference current may be converted into a second voltage. In one embodiment, portions of the current-to-voltage converter 130 of FIG. 1 may perform this conversion as described above. Specifically, in one illustrative embodiment, the transistors 316, 318 and 320 may perform this conversion, as described above. In one embodiment, the second voltage may be the second voltage signal 137 (Von), described above.

Block 770 illustrates that, in one embodiment, the first and second voltages may be utilized to detect an over-current condition. In one embodiment, portions of the current-mirror amplifier 140 of FIG. 1 may perform this detection as described above. In one embodiment, the over-current detection may result in the generation of the over-current condition signal 190 (overi), described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
an over-current detector configured to receive a switching voltage signal and to produce a first and a second current signal;
a current-to-voltage converter configured to convert the first current signal into a first voltage signal, and the second current signal into a second voltage signal; and
a current mirror amplifier configured to utilize the first and second voltage signals to output an over-current condition signal when the switching signal has exceeded a threshold value.

2. The system of claim 1, wherein the over-current detector comprises:
first circuitry configured to generate a biasing voltage;
second circuitry configured to generate the first current signal based, at least in part, upon a selection of either a source voltage signal or a switching voltage signal; and
third circuitry configured to generate the second current signal based upon a reference voltage.

3. The system of claim 2 further comprising a capacitor that provides the biasing voltage and wherein the first circuitry is further configured to pre-charge the capacitor.

4. The system of claim 3 wherein the first circuitry is configured such that the capacitor is operatively connected to a source and a gate of a transistor.

5. The system of claim 2 wherein the second circuitry comprises a selector that selects between the source voltage signal and the switching voltage signal.

6. The system of claim 5 wherein an output of the selector is operatively connected to a source of a voltage-to-current converting transistor.

7. The system of claim 2 wherein the third circuitry is configured to generate the second current signal based upon a programmable reference voltage generator.

8. The system of claim 7 wherein the third circuitry includes a voltage-to-current converting transistor, and
a gate of the voltage-to-current converting transistor is electrically connected with an output terminal of the first circuitry having the biasing voltage.

9. The system of claim 1 further comprising at least one active solid-state device operatively coupled with the current-to-voltage converter and wherein the current-to-voltage converter is configured to utilize at least one active solid-state device to actively adjust the resistance of the current-to-voltage converter.

10. The system of claim 1 wherein the current-to-voltage converter comprises a trans-impedence amplifier.

11. A circuit comprising:
a group of high-voltage (HV) power-down switches configured to receive a switching voltage signal and to reduce, at least in part, a voltage stress experienced by a group of high-voltage (HV) voltage-to-current converters, wherein at least a portion of the HV power-down switches is controlled by a control signal; and
a programmable voltage reference generator configured to generate a reference voltage;
wherein the group of high-voltage (HV) voltage-to-current converters is configured to receive an output of the HV power-down switches and to receive an output of the programmable voltage reference generator, and to produce a first current signal and a second current signal.

12. The circuit of claim 11 wherein the high-voltage (HV) voltage-to-current converters comprise a gate bias voltage generator configured to prevent the high voltage breakdown of at least a portion of the group of high-voltage (HV) voltage-to-current converters.

13. The circuit of claim 12 wherein the HV voltage-to-current converters comprise a transistor wherein the gate of the transistor is configured to receive the bias voltage, and wherein the source of the transistor is configured to receive either a source voltage signal or the switching voltage signal.

14. The circuit of claim 12 wherein the gate bias voltage generator comprises a biasing transistor and a capacitor, and wherein the capacitor is connected across the source and gate of the biasing transistor.

15. The circuit of claim 11 wherein the high-voltage (HV) power-down switches comprise four sets of two cascaded transistors.

16. The circuit of claim 15 wherein a two of the four sets of transistors are configured to select between a source voltage or a switching voltage.

17. The circuit of claim 15 wherein the programmable voltage reference generator is configured to receive an output of one of the four sets of transistors and generate a reference voltage utilizing a reference current.

18. The circuit of claim 11 wherein, during operation, the selection of either the source voltage signal or the switching voltage signal by the two of the four sets of transistors is determined by the value of the control signal.

19. The circuit of claim 11 the circuit further comprising:
a trans-impedance amplifier configured to convert the first and a second current signals into first and second voltage signals; and
a comparator configured to determine, utilizing the first and second voltage signals, if an over-current condition exists.

20. A method comprising:
utilizing a control signal to select either a source voltage or a switching voltage;
converting the selected voltage to a selected current;
converting the selected current to a first voltage;
generating a programmable reference current;
converting the programmable reference current to a second voltage; and
utilizing the first and second voltages to detect an over-current condition.
